(19) United States
(12) Patent Application Publication
(10) Pub. No.: US 2024/0143699 A1
(43) Pub. Date: May 2, 2024

(54) CONSENSUS GRAPH LEARNING-BASED MULTI-VIEW CLUSTERING METHOD

(71) Applicant: ZHEJIANG NORMAL UNIVERSITY, Jinhua (CN)

(72) Inventors: Xinzhong ZHU, Jinhua (CN); Huiying XU, Jinhua (CN); Zhenglai LI, Jinhua (CN); Chang TANG, Jinhua (CN); Jianmin ZHAO, Jinhua (CN)

(73) Assignee: ZHEJIANG NORMAL UNIVERSITY, Jinhua (CN)

(21) Appl. No.: 18/276,047

(22) PCT Filed: Dec. 7, 2021
(86) PCT No.: PCT/CN2021/135989

§ 371 Date: Aug. 7, 2023

(30) Foreign Application Priority Data
Feb. 8, 2021 (CN) 202110171227.2

(51) Int. Cl. G06F 18/2323; G06F 17/14

(52) U.S. Cl. CPC G06F 18/2323; G06F 17/142

(57) ABSTRACT

A consensus graph learning-based multi-view clustering method includes: S11, inputting an original data matrix to obtain a spectral embedding matrix; S12, calculating a similarity graph matrix and a Laplacian matrix based on the spectral embedding matrix; S13, applying spectral clustering to the calculated similarity graph matrix to obtain spectral embedding representations; S14, stacking inner products of the normalized spectral embedding representations into a third-order tensor and using low-rank tensor representation learning to obtain a consistent distance matrix; S15, integrating spectral embedding representation learning and low-rank tensor representation learning into a unified learning framework to obtain a objective function; S16, solving the obtained objective function through an alternative iterative optimization strategy; S17, constructing a consistent similarity graph based on the solved result; and S18, applying spectral clustering to the consistent similarity graph to obtain a clustering result. A consistent similarity graph for clustering is constructed based on spectral embedding features.

### CROSS REFERENCE TO THE RELATED APPLICATIONS

This application is the national phase entry of International Application No. PCT/CN2021/135989, filed on Dec. 7, 2021, which is based upon and claims priority to Chinese Patent Application No. 202110171227.2, filed on Feb. 8, 2021, the entire contents of which are incorporated herein by reference.

### TECHNICAL FIELD

The present application relates to the technical field of signal processing and data analysis, and in particular to a consensus graph learning-based multi-view clustering method.

### BACKGROUND

With the advancement of information acquisition technologies, multimedia data such as text, audio, image, and video can often be acquired from various sources in real-world application scenarios. For example, in multimedia image retrieval tasks, color, texture, and edges can be used to describe images, while in video scene analysis tasks, cameras from different angles can provide additional information for analyzing the same scene. This type of data is referred to as multi-view data, giving rise to a series of multi-view learning algorithms, including cross-view domain adaptation, multi-view clustering, and multi-view anomaly detection. The acquisition of semantic information from data is an important research topic in multimedia data mining. Multi-view clustering analyzes the multi-view features of data in an unsupervised manner to capture the intrinsic cluster information, and it has gained increasing attention in recent years. Spectral clustering has become a popular clustering algorithm due to its solid mathematical framework and the ability to partition clusters of arbitrary shapes. Consequently, in recent years, an increasing number of multi-view clustering algorithms based on spectral clustering have been proposed and applied to analyze and process multimedia data. Most multi-view clustering algorithms based on spectral clustering typically involve the following two steps: first, constructing a shared similarity graph from the multi-view data, and then applying spectral clustering on the similarity graph to obtain the clustering results. Due to the heterogeneity of multimedia acquisition sources, multi-view data often exhibit features such as redundancy, correlation, and diversity. This poses a key challenge in how to effectively mine the information from multi-view data to construct a high-quality similarity graph for clustering, thereby improving the clustering performance of multi-view clustering algorithms. To address the challenge, Gao et al. combined subspace learning with spectral clustering to learn a shared clustering partition for multi-view data. Cao et al. enforced the differences between multiple subspace representations using the Hilbert-Schmidt criterion to explore the complementary information between views. Wang et al. introduced an exclusive regularization constraint to ensure sufficient differences among multiple subspace representations while obtaining a consistent clustering partition from multiple subspace representations. Nie et al. combined clustering and local structure learning to obtain a similarity graph with a Laplacian rank constraint. The above methods typically employ pairwise strategies to explore the differences and consistency information between views to improve clustering performance. In contrast, in recent years, some algorithms have achieved better clustering effects and gained increasing attention by stacking multiple representations into tensors and further exploring the high-order correlations of the data.

While previous multi-view clustering algorithms have improved clustering performance in various aspects, they often directly learn the similarity graph from the original features that contain noise and redundant information. As a result, the obtained similarity graph is not accurate, limiting the clustering performance.

To address the issue, the present application provides a Consensus Graph Learning-based Multi-View Clustering (CGLMVC) method that learns a consistent similarity graph for clustering from a new feature space.

### SUMMARY

Aiming at the existing defects in the prior art, the present application provides a consensus graph learning-based multi-view clustering method.

To achieve the above objective, the present application adopts the following technical solutions:

Provided is a consensus graph learning-based multi-view clustering method, including:
S1, inputting an original data matrix to obtain a spectral embedding matrix;
S2, calculating a similarity graph matrix and a Laplacian matrix based on the spectral embedding matrix;
S3, applying spectral clustering to the calculated similarity graph matrix to obtain spectral embedding representations;
S4, stacking inner products of the normalized spectral embedding representations into a third-order tensor and using low-rank tensor representation learning to obtain a consistent distance matrix;
S5, integrating spectral embedding representation learning and low-rank tensor representation learning into a unified learning framework to obtain a objective function;
S6, solving the obtained objective function through an alternative iterative optimization strategy;
S7, constructing a consistent similarity graph based on the solved result;
S8, applying spectral clustering to the consistent similarity graph to obtain a clustering result.

Further, obtaining spectral embedding representations in step S3 is expressed as:

max_{H}_{^{(v)}}Tr(H^{(v)T}A^{(v)}H^{(v)}) s.t. H^{(v)}H^{(v)T}=I_{c}

wherein H^{(v)} ∈ [symbol] ^{n×c} represents a spectral embedding matrix of the v-th view; A^{(v)} represents a Laplacian matrix of the v-th view; n represents a number of data samples; c represents a number of clusters; Tr( )represents a trace of a matrix; H^{(v)T} represents transpose of H^{(v)}; I_{c} represents a c×c identity matrix.

Further, using low-rank tensor representation learning to obtain a consistent distance matrix in step S4 is expressed as:

$${min}_{𝒯} \frac{1}{2} {‖ ℬ - 𝒯 ‖}_{F}^{2} + {‖ 𝒯 ‖}_{w , *} s . t . ℬ = Φ ( {\overline{H}}^{( 1 )} {\overline{H}}^{( 1 ) ⊤} , … , {\overline{H}}^{( V )} {\overline{H}}^{( V ) ⊤} )$$

wherein [symbol] ∈ [symbol] ^{n×V×n} represents a third-order tensor; [symbol] ∈ [symbol] ^{n×V×n} represents a third-order tensor; V represents a number of views; ∥∥_{F} represents a norm of a tensor; ∥∥_{w,*} represents a weighted tensor nuclear norm; Φ( )represents a stacking of matrices into a tensor; H̅⁽¹⁾ and H̅^{(v)} represent normalized spectral embedding representations of the first and V-th views, respectively, and H̅^{(1)T} and H̅^{(V)T} represent transposes thereof, respectively. Further, obtaining the objective function in step S5 is expressed as:

$${min}_{{H}^{( v )} , 𝒯} - λ {\sum }_{v = 1}^{V} Tr ( {H}^{( v ) ⊤} {A}^{( v )} {H}^{( v )} ) + \frac{1}{2} {‖ ℬ - 𝒯 ‖}_{F}^{2} + {‖ 𝒯 ‖}_{w , *} s . t . \\ {H}^{( v ) ⊤} {H}^{( v )} = {I}_{c}$$

wherein λ represents a penalty parameter.

Further, step S6 specifically includes:

S61, fixing [symbol] and unfolding tensors [symbol] and [symbol] into matrix form by discarding irrelevant terms, then the objective function being expressed as:

$${min}_{{H}^{( v )}} - λ Tr ( {H}^{( v ) ⊤} {A}^{( v )} {H}^{( v )} ) + \frac{1}{2} {‖ {\overline{H}}^{( v )} {\overline{H}}^{( v ) ⊤} - {T}^{( v )} ‖}_{F}^{2} s . t . \\ {H}^{( v ) ⊤} {H}^{( v )} = {I}_{c}$$

wherein T^{(v)} represents the ν-th lateral slice of [symbol] ;

S62, making P^{(v)} ∈ [symbol] ^{n×n} represent a diagonal matrix, then diagonal elements being defined as:

$${P}_{ij}^{( v )} = \{ \begin{matrix}\frac{1}{\sqrt{{h}_{i}^{( v ) ⊤} {h}_{i}^{( v )}}} , & if i = j \\ 0 , & otherwise\end{matrix}$$

wherein hᵢ^{(v)} and hⱼ^{(v)} represent the i-th and j-th rows of spectral embedding matrix H^{(v)}, respectively; hᵢ^{(v)T} represents a transpose of hⱼ^{(v)}; solving {H^{(v)}}ᵥ₌₁^{V};

S63, fixing {H^{(v)}}ᵥ₌₁^{V} and discarding other irrelevant terms, then the objective function being expressed as:

$${min}_{𝒯} \frac{1}{2} {‖ ℬ - 𝒯 ‖}_{F}^{2} + {‖ 𝒯 ‖}_{w , *} \\ {min}_{\overline{𝒯} ( : , : , j )} \frac{1}{n} {\sum }_{j = 1}^{n} ( \frac{1}{2} {‖ \overline{ℬ} ( : , : , j ) - \overline{𝒯} ( : , : , j ) ‖}_{F}^{2} + {‖ \overline{𝒯} ( : , : , i ) ‖}_{w , *} )$$

wherein [symbol] (:;:; j) and ι̅(:;:; j) represent the j -th slice of [symbol] and [symbol] , respectively; [symbol] and [symbol] represent results of fast Fourier transform along the third dimension for [symbol] and [symbol] , respectively;

S64, solving [symbol] (:;:; j) to obtain a solution of the objective function.

Further, constructing a consistent similarity graph in step S7 is expressed as:

$${min}_{S} {\sum }_{v = 1}^{V} {\sum }_{i = 1}^{n} {\sum }_{j = 1}^{n} {‖ {\overline{h}}_{i}^{( v )} - {\overline{h}}_{j}^{( v )} ‖}_{2}^{2} {S}_{ij} + γ {‖ S ‖}_{F}^{2} s . t . {s}_{ij} \geq 0 , {s}_{i} {1}_{n} = 1$$

wherein h̅ᵢ^{(v)} and h̅ⱼ^{(v)} represent the i-th and j-th rows of H̅^{(v)}, respectively; S represents a consistent similarity graph; γ represents a penalty parameter.

Further, for solving [symbol] (:;:; j) in step S64, the [symbol] (:;:; j) has the following approximate solution:

[symbol]

(:;:; j)= [symbol] (:;:; j)* [symbol] (:;:; j)* [symbol] (:;:; j)*

wherein [symbol] (:;:; j)= [symbol] (:;:; j)* [symbol] (:;:; j)* [symbol] (:;:; j)* represents a singular value decomposition of [symbol] (:;:; j); [symbol] (:;:; j) is defined as:

$$\tilde{\overline{𝒮}} ( i , i , j ) = \{ \begin{matrix}0 , & if {c}_{2} < 0 \\ \frac{{c}_{1} + \sqrt{{c}_{2}}}{2} , & if {c}_{2} \geq 0\end{matrix} ,$$

wherein c₁ [symbol] (i, i, j)=ϵ, c₂= [symbol] (i, i, j)+ϵ²−4C. ϵ is a positive value small enough that the inequality

$$ϵ < min ( \sqrt{C} , \frac{C}{\overline{𝒮} ( i , i , j )} )$$

holds; C is a constraint parameter for setting the weight

$${w}_{i}^{( j )} , {w}_{i}^{( j )} = \frac{C}{\overline{𝒮} ( i , i , j ) + ϵ} .$$

Compared with the prior art, the present application provides a consensus graph learning-based multi-view clustering method and constructs a consistent similarity graph for clustering based on spectral embedding features. In this low-dimensional space, noise and redundant information are effectively filtered out, resulting in a similarity graph that well describes the cluster structure of the data.

### BRIEF DESCRIPTION OF THE DRAWINGS

FIG. 1 is a flowchart of the consensus graph learning-based multi-view clustering method according to Embodiment I;

FIG. 2 is a block diagram of the algorithm of the CGLMVC method according to Embodiment I;

FIGS. 3A-3F are schematic diagrams of ACC results on six datasets under different parameter combinations according to Embodiment II;

FIGS. 4A-4F are schematic diagrams of NMI results on six datasets under different parameter combinations according to Embodiment II;

FIGS. 5A-5F are schematic diagrams of Purity results on six datasets under different parameter combinations according to Embodiment II; and

FIGS. 6A-6F are schematic diagrams of convergence curves of the objective function for the CGLMVC method on six datasets according to Embodiment II.

### DETAILED DESCRIPTION OF THE EMBODIMENTS

The embodiments of the present application are illustrated below through specific examples, and other advantages and effects of the present application can be easily understood by those skilled in the art based on the contents disclosed herein. The present application can also be implemented or applied through other different specific embodiments. Various modifications or changes to the details described in the specification can be made based on different perspectives and applications without departing from the spirit of the present application. It should be noted that, unless conflicting, the embodiments and features of the embodiments may be combined with each other.

Aiming at the existing defects, the present application provides a consensus graph learning-based multi-view clustering method.

### EMBODIMENT I

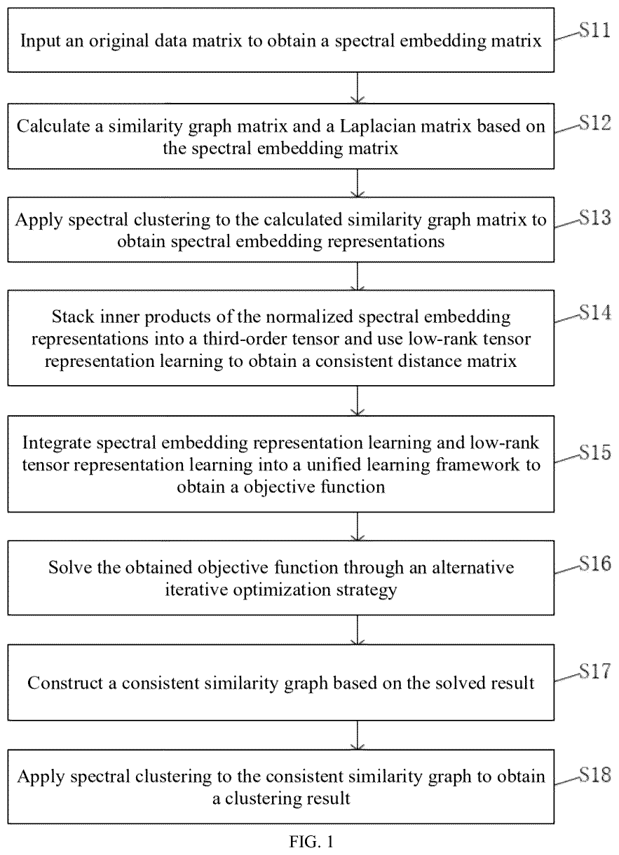

As shown in FIG. 1, the consensus graph learning-based multi-view clustering method provided by the embodiment includes:

S11, inputting an original data matrix to obtain a spectral embedding matrix;

S12, calculating a similarity graph matrix and a Laplacian matrix based on the spectral embedding matrix;

S13, applying spectral clustering to the calculated similarity graph matrix to obtain spectral embedding representations;

S14, stacking inner products of the normalized spectral embedding representations into a third-order tensor and using low-rank tensor representation learning to obtain a consistent distance matrix;

S15, integrating spectral embedding representation learning and low-rank tensor representation learning into a unified learning framework to obtain a objective function;

S16, solving the obtained objective function through an alternative iterative optimization strategy;

S17, constructing a consistent similarity graph based on the solved result;

S18, applying spectral clustering to the consistent similarity graph to obtain a clustering result.

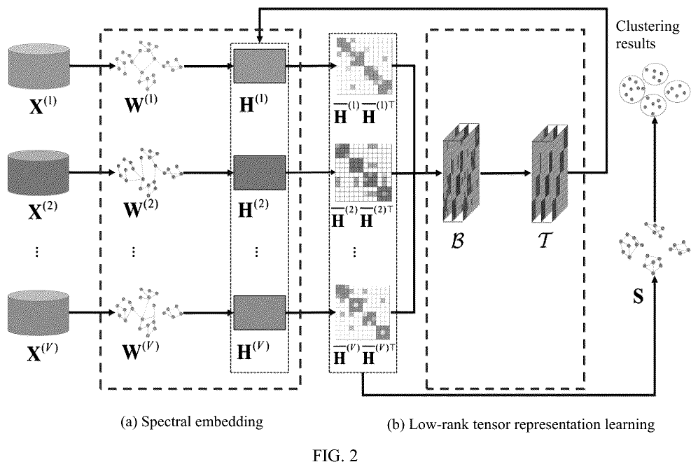

The embodiment provides a consensus graph learning-based multi-view clustering (CGLMVC) method that learns a consistent similarity graph for clustering from a new feature space. Specifically, spectral embedding representations are firstly obtained from the similarity graphs of each view, and the inner products of multiple normalized spectral embedding representations are stacked into a third-order tensor. Then, high-order consistency information among multiple views is mined using the weighted tensor nuclear norm. The spectral embedding and low-rank tensor learning are further integrated into a unified learning framework to jointly learn spectral embedding and tensor representation. The embodiment takes into account the distribution differences of noise and redundancy across multiple views. By constraining the global consistency of multiple views, noise and redundant information can be effectively filtered out. Therefore, the learned spectral embedding representations are more suitable for constructing the intrinsic similarity graph of the data for clustering tasks. Based on the solved spectral embedding features, a consistent similarity graph can be constructed for clustering. FIG. 2 shows a block diagram of the algorithm of the CGLMVC method.

For real-world data, noise and redundant information inevitably mix in the original features. Therefore, the similarity graph learned from the original features is not accurate. To address the issue, an adaptive neighborhood graph is learned in a new low-dimensional feature space. The adaptive neighborhood graph can be obtained by solving the following problem:

$${min}_{S} {\sum }_{v = 1}^{V} {\sum }_{i = 1}^{n} {\sum }_{j = 1}^{n} {‖ {\overline{h}}_{i}^{( v )} - {\overline{h}}_{j}^{( v )} ‖}_{2}^{2} {S}_{ij} + γ {‖ S ‖}_{F}^{2} s . t . {s}_{ij} \geq 0 , {s}_{i} {1}_{n} = 1.$$

wherein h̅ᵢ^{(v)} and h̅ⱼ^{(v)} represent the i -th and j-th rows of the normalized spectral embedding matrix H̅ᵢ^{(v)} H (v). H̅ᵢ^{(v)} is obtained by normalizing each row of H^{(v)} to have a uniform Euclidean length, such as

$${\overline{h}}_{i}^{( v )} = \frac{{h}_{i}^{( v )}}{\sqrt{{h}_{i}^{( v ) ⊤} {h}_{i}^{( v )}}} .$$

Through the normalization operation, the k-dimensional spectral embedding representations corresponding to the samples are distributed on a unit hypersphere. Similarity graphs based on Euclidean distance can effectively capture the cluster structure of the data in this case.

In step S11, an original data matrix is input to obtain a spectral embedding matrix.

The original data matrix is {X^{(v)}}ᵥ₌₁^{V}, wherein X^{(v)} ∈ [symbol] ^{n×d}^{_{V}}, dᵥ represents the dimension of the feature in the v-th view, n represents the number of data samples, and V represents the number of views.

In step S12, a similarity graph matrix and a Laplacian matrix are calculated based on the spectral embedding matrix.

The spectral embedding matrix can be obtained by applying spectral clustering to the view-specific similarity graph W^{(v)}. The objective function is as follows:

max_{H}_{^{(v)}} Tr(H^{(v)T}A^{(v)})s.t.H^{(v)}H^{(v)T=}I_{c}

wherein H^{(v)}∈ [symbol] ^{n×c} represents a spectral embedding matrix of the v-th view; A^{(v)} represents a Laplacian matrix of the v-th view; nl represents a number of data samples; c represents a number of clusters; Tr( )represents a trace of a matrix; H^{(v)T} represents transpose of H^{(v)}; I_{c} represents a c×c identity matrix.

The S obtained in the above formula mainly depends on the distance matrix D^{h(v)}, such as Dᵢⱼ^{h(v)=∥h̅}ᵢ^{(v)-h̅}ⱼ^{(v) ∥}₂²=2−2h̅ᵢ^{(v)}h̅ⱼ^{(v)}. Therefore, the problem of learning the similarity graph is transformed into learning a robust and comprehensive matrix D^{h(v)}. Since the correlation between views is not taken into account, there is a lack of global consistency among multiple distance matrices. As a result, the complementary information between views cannot be well utilized, and therefore, it is necessary to perform step S14.

In step S14, inner products of the normalized spectral embedding representations are stacked into a third-order tensor to obtain the low-rank tensor representation learning. {H̅^{(v)}H̅^{(v)T}}ᵥ₌₁^{V} is stacked as a third-order tensor [symbol] ∈ [symbol] ^{n×V×n}, the similarity of samples across multiple views should be consistent due to the potential semantic consistency in multi-view data, and [symbol] should be a low-rank tensor. The low-rank tensor representation learning can be expressed as:

$${min}_{𝒯} \frac{1}{2} {‖ ℬ - 𝒯 ‖}_{F}^{2} + {‖ 𝒯 ‖}_{w , *} s . t . ℬ = Φ ( {\overline{H}}^{( 1 )} {\overline{H}}^{( 1 ) ⊤} , … , {\overline{H}}^{( V )} {\overline{H}}^{( V ) ⊤} )$$

wherein [symbol] ∈ [symbol] ^{n×V×n} represents the third-order tensor, [symbol] ∈ [symbol] ^{n×V×n} represents the third-order tensor, V represents the number of views, H̅^{(v)} represents the normalized spectral embedding representation, ∥∥_{F} represents the norm of the tensor, ∥∥_{w,*} epresents the weighted tensor nuclear norm, Φ( ) represents the stacking of matrices into a tensor, H̅⁽¹⁾ and H̅^{(V)} represent the normalized spectral embedding representations of the first and V -th views, respectively, and H̅^{(1)T} and H̅^{(V)T} represent transposes thereof, respectively.

In step S15, spectral embedding representation learning and low-rank tensor representation learning are integrated into a unified learning framework to obtain a objective function. The objective function of the consensus graph learning-based multi-view clustering method provided by the embodiment can be expressed as follows:

$${min}_{{H}^{( v )} , 𝒯} - λ {\sum }_{v = 1}^{V} Tr ( {H}^{( v ) ⊤} {A}^{( v )} {H}^{( v )} ) + \frac{1}{2} {‖ ℬ - 𝒯 ‖}_{F}^{2} + τ {‖ 𝒯 ‖}_{*} s . t . \\ {H}^{( v ) ⊤} {H}^{( v )} = {I}_{c}$$

wherein λ represents a penalty parameter, τ represents the singular value threshold, and [symbol] ∈ [symbol] ^{n×V×n} represents a third-order tensor. The first term of the formula is spectral embedding, which aims to obtain low-dimensional representations while preserving the local characteristics of the data. The second and third terms are used to mine the principal components of the tensor [symbol] and constrain the consistency in the matrix {H̅^{(v)}H̅^{(v)T}}ᵥ₌₁^{V}. The low-rank tensor [symbol] can be solved using the tensor singular value thresholding operator:

[symbol]

_{σ}( [symbol] )= [symbol] * [symbol] * [symbol] *

wherein [symbol] =ifft(( [symbol] −τ)_{+,} []3), t₃₀ =max(t, 0).

In the above formula, each singular value undergoes a shrinking operation using the same singular value threshold τ. However, relatively larger singular values quantify the information about the principal components and thus should undergo less shrinking operations. Excessive penalization of larger singular values hinders the mining of key information from the tensor. Therefore, in the embodiment, a weighted tensor nuclear norm is introduced to enhance the flexibility of the tensor nuclear norm. The weighted tensor nuclear norm is expressed as follows:

$${‖ 𝒯 ‖}_{w , *} = {\sum }_{i = 1}^{r} {\sum }_{j = 1}^{n} {w}_{i}^{( j )} \overline{𝒮} ( i , i , j )$$

wherein wᵢ^{(j)} represents the singular value weights.

By replacing the nuclear norm in the above objective function with the weighted tensor nuclear norm, the final objective function is obtained.

The objective function of the consensus graph learning-based multi-view clustering method provided by the embodiment can be expressed as follows:

$${min}_{{H}^{( v )} , 𝒯} - λ {\sum }_{v = 1}^{V} Tr ( {H}^{( v ) ⊤} {A}^{( v )} {H}^{( v )} ) + \frac{1}{2} {‖ ℬ - 𝒯 ‖}_{F}^{2} + {‖ 𝒯 ‖}_{w , *} s . t . \\ {H}^{( v ) ⊤} {H}^{( v )} = {I}_{c}$$

wherein λ, represents a penalty parameter.

By solving the objective function, the consistent similarity graph S can be obtained using the adaptive neighborhood graph learning method from the matrix {H̅^{(v)}H̅^{(v)T}}ᵥ₌₁^{V}. In the provided CGLMVC algorithm, the distribution of noise and redundancy is treated differently across multiple views. By constraining the global consistency of multiple views, noise and redundant information can be effectively filtered out. Therefore, the learned spectral embedding representations are more suitable for constructing the intrinsic similarity graph of the data for clustering tasks.

In step S16, the obtained objective function is solved through an alternative iterative optimization strategy, which specifically includes:

S61, fixing the variable [symbol] and unfolding tensors [symbol] and [symbol] into matrix form by discarding irrelevant terms, then the objective function being expressed as:

$${min}_{{H}^{( v )}} - λ Tr ( {H}^{( v ) ⊤} {A}^{( v )} {H}^{( v )} ) + \frac{1}{2} {‖ {\overline{H}}^{( v )} {\overline{H}}^{( v ) ⊤} - {T}^{( v )} ‖}_{F}^{2} s . t . \\ {H}^{( v ) ⊤} {H}^{( v )} = {I}_{c}$$

wherein T^{(v)} represents the ν-th lateral slice of [symbol] , such as T^{(v)}= [symbol] (:, v,:). The above formula can be further rewritten as follows:

$${min}_{{H}^{( v )}} - λ Tr ( {H}^{( v ) ⊤} {A}^{( v )} {H}^{( v )} ) + \frac{1}{2} Tr ( {\overline{H}}^{( v )} {\overline{H}}^{( v ) ⊤} {\overline{H}}^{( v )} {\overline{H}}^{( v ) ⊤} ) - \frac{1}{2} Tr ( {\overline{H}}^{( v )} {\overline{H}}^{( v ) ⊤} ( {T}^{( v )} + {T}^{( v ) ⊤} ) )$$

$$s . t . {H}^{( v ) ⊤} {H}^{( v )} = {I}_{c}$$

S62, making P^{(v)} ∈ [symbol] ^{n×n} represent a diagonal matrix, then diagonal elements being defined as:

$${P}_{ij}^{( v )} = \{ \begin{matrix}\frac{1}{\sqrt{{h}_{i}^{( v ) ⊤} {h}_{i}^{( v )}}} , & if i = j \\ 0 , & otherwise\end{matrix}$$

wherein hᵢ^{(v)} and hⱼ^{(v)} represent the i-th and j-th rows of spectral embedding matrix H^{(v)}, respectively; hᵢ^{(v)T} represents a transpose of hⱼ^{(v)}; thus, the following equation holds:

H̅^{(v)}=P^{(v)}H^{(v)}

By integrating the above formulas, the optimization problem can be further rewritten as follows:

max_{H}_{^{(v)}}Tr(H^{(v)T}G^{(v)}H^{(v)})s.t. H^{(v)T}H^{(v)}=I_{c}

wherein

$${G}^{( v )} = λ {A}^{( v )} + \frac{1}{2} {P}^{( v )} ( {T}^{( v )} + {T}^{( v ) ⊤} ) {P}^{( v )} - \frac{1}{2} {P}^{( v )} {\overline{H}}^{( v )} {\overline{H}}^{( v ) ⊤} {P}^{( v )} ,$$

and the optimal solution for H^{(v)} can be obtained by selecting the eigenvectors corresponding to the c largest eigenvalues of the matrix G^{(v)}.

S63, fixing the variable {H^{(v)}}ᵥ₌₁^{V} and discarding other irrelevant terms, then the objective function being expressed as:

$${min}_{𝒯} \frac{1}{2} {‖ ℬ - 𝒯 ‖}_{F}^{2} + {‖ 𝒯 ‖}_{w , *}$$

wherein for tensor χ∈Rⁿ^{₁}^{×n}^{₂}^{n×n}^{₃}, there is

$${‖ 𝒳 ‖}_{F} = \frac{1}{\sqrt{{n}_{3}}} {‖ \overline{𝒳} ‖}_{F} ;$$

thus, the above formula has the following equivalent formulation:

$${min}_{\overline{𝒯} ( : , : , j )} \frac{1}{n} {\sum }_{j = 1}^{n} ( \frac{1}{2} {‖ \overline{ℬ} ( : , : , j ) - \overline{𝒯} ( : , : , j ) ‖}_{F}^{2} + {‖ \overline{𝒯} ( : , : , i ) ‖}_{w , *} )$$

wherein [symbol] (:,:, j) and [symbol] (:,:, j) represent the j-th slice of [symbol] and [symbol] , respectively; [symbol] and [symbol] represent results of fast Fourier transform along the third dimension for [symbol] and [symbol] , respectively, such as [symbol] =fft( [symbol] , [], 3), [symbol] =fft( [symbol] , [], 3).

S64, solving [symbol] (:,:, j) to obtain a solution of the objective function.

[symbol] (:, :, j) has the following approximate solution:

[symbol]

(:, :, j)= [symbol] (:,:, j)* [symbol] (:,:, j)* [symbol] (:, :, j)*

wherein [symbol] (:, :, j)= [symbol] (:, :, j)* [symbol] (:, :, j)* [symbol] (:, :, j) represents a singular value decomposition of [symbol] (:, :,j); [symbol] (:, :, j) is defined as:

$$\tilde{\overline{S}} ( i , i , j ) = \{ \begin{matrix}0 , & if {c}_{2} < 0 \\ \frac{{c}_{1} + \sqrt{{c}_{2}}}{2} , & if {c}_{2} \geq 0\end{matrix} ,$$

wherein c₁= [symbol] (i, i, j)=ϵ, c₂=( [symbol] (i,i,j)+ϵ)²−4C. ϵ is a positive value small enough that the inequality

$$ϵ < min ( \sqrt{C} , \frac{C}{\overline{S} ( i , i , j )} )$$

holds; C is a constraint parameter for setting the weight wᵢ^{(j)}, such as

$${w}_{i}^{( j )} = \frac{C}{\overline{S} ( i , i , j ) + ϵ} .$$

In step S17, constructing a consistent similarity graph is expressed as:

$${min}_{S} {{\sum }_{v = 1}}^{V} {\sum }_{i = 1}^{n} {{\sum }_{j = 1}}^{n} {‖ {\overline{h}}_{i}^{( v )} - {\overline{h}}_{j}^{( v )} ‖}_{2}^{2} {S}_{ij} + γ {‖ S ‖}_{F}^{2} s . t . {s}_{ij} \geq 0 , {s}_{i} {1}_{n} = 1$$

wherein h̅ᵢ^{(v)} and h̅ᵢ^{(v)} represent the i-th and j-th rows of H̅^{(v)}, respectively; S represents a consistent similarity graph; γ represents a penalty parameter.

The embodiment provides a consensus graph learning-based multi-view clustering method (CGLMVC). Compared to other multi-view clustering algorithms such as LT-MSC, MLAN, GMC, and SM2SC, the CGLMVC method constructs a consistent similarity graph for clustering based on spectral embedding features. In this low-dimensional space, noise and redundant information are effectively filtered out, resulting in a similarity graph that well describes the cluster structure of the data. FIG. 2 shows a block diagram of the algorithm of the CGLMVC algorithm. Through the joint learning of spectral embedding and low-rank tensor representation, the CGLMVC method preserves the original geometric structure of the data while achieving high-order view consistency in the spectral embedding features. Furthermore, an effective iterative algorithm is devised to optimize solving of the objective function of the CGLMVC method.

### EMBODIMENT II

The difference between the consensus graph learning-based multi-view clustering method provided in this embodiment and that in Embodiment I is as follows:

To fully verify the effectiveness of the CGLMVC method of the present application, the performance of the CGLMVC method is first tested on six commonly used underlying databases (MSRCV1, ORL, 20newsgroups, 100leaves, COIL20, handwritten). A comparison is made with the following two single-view clustering algorithms and seven currently popular multi-view clustering algorithms:

(1) SC: spectral clustering algorithm.

(2) LRR: This method uses nuclear norm constraint to construct a low-rank subspace representation for clustering.

(3) MLAN: This method automatically assigns weights to each view and learns a similarity graph with Laplacian rank constraints for clustering.

(4) MCGC: This method reduces the differences between views using a collaborative regularization term and learns a similarity graph with Laplacian rank constraints for clustering from multiple spectral embedding matrices.

(5) GMC: This method integrates adaptive neighborhood graph learning and multiple similarity graph fusion into a unified framework to learn a similarity graph with Laplacian rank constraints for clustering.

(6) SM2SC: This method uses variable splitting and multiplicative decomposition strategies to mine the intrinsic structure of multiple views from view-specific subspace representations and constructs a structured similarity graph for clustering.

(7) LT-MSC: This method stacks multiple subspace representations into a tensor and learns a low-rank tensor subspace representation for clustering by constraining the three modes of the tensor to have a low rank.

(8) t-SVD-MS: This method stacks multiple subspace representations into a tensor and learns a low-rank tensor subspace representation for clustering by constraining the tensor to have a low rank using tensor nuclear norm based on tensor singular value decomposition.

(9) ETLMSC: This method stacks multiple probability transition matrices into a tensor and learns the intrinsic probability transition matrix using tensor nuclear norm and l_{2, 1} norm. Then, the final clustering results are obtained from the intrinsic probability transition matrix using spectral clustering based on Markov chain.

In the experiments, the CGLMVC method was compared with nine other clustering methods on six publicly available databases. The specific information about the six databases is as follows: MSRCV1: It contains a total of 210 images for scene recognition of seven categories. Each image is described using six different types of features, such as 256-dimensional LBP features, 100-dimensional HOG features, 512-dimensional GIST features, 48-dimensional Color Moment features, 1302-dimensional CENTRIST features, and 210-dimensional SIFT features. ORL: It contains a total of 400 face images of 40 individuals under different lighting conditions, times, and facial details. In the experiment, three different types of features, such as 4096-dimensional intensity features, 3304-dimensional LBP features, and 6750-dimensional Gabor features, are used to describe each face image.

20newsgroups: It is a document dataset that contains a total of 500 samples of five categories. In the experiment, three different document preprocessing techniques result in three different types of features.

100leaves: This dataset contains a total of 1600 plant images of 100 categories. In the experiment, three different types of features, including shape, texture, and edge from each image were extracted according to the embodiment.

COIL20: It contains a total of 1400 object images of 20 categories. For each image, 1024-dimensional intensity features, 3304-dimensional LBP features, and 6750-dimensional Gabor features were extracted according to the embodiment.

handwritten: It contains a total of 2000 handwritten digit images ranging from 0 to 9. For each image, 76-dimensional FOU features, 216-dimensional FAC features, 64-dimensional KAR features, 240-dimensional Pix features, 47-dimensional ZER features, and 6-dimensional MOR features were extracted according to the embodiment.

SC and LRR are two single-view clustering algorithms. According to the embodiment, the two single-view clustering algorithms were applied to each view of the data, and the best clustering results were obtained. For the SC algorithm, the number of nearest neighbors for the adaptive neighborhood similarity graph was set to 15. For the LRR algorithm, parameters were selected from the range of [10⁻³, 10⁻², . . . 10²,10³] using a grid search strategy. For the MLAN and GMC algorithms, the number of nearest neighbors was set to 9 and 15, respectively, according to the settings in their respective papers. For the MCGC algorithm, the number of nearest neighbors was set to 15, and the regularization parameter was selected from [0.6:5:100]. For the SM2SC algorithm, the three hyperparameters were selected from [0.1, 0.15, 0.2, 0.3, 0.4, 0.5,1,10, 40,100] , [0.1, 0.5,1,1.5, 2], and [0.05, 0.1, 0.4,1, 5], respectively. For the LT-MSC algorithm, the hyperparameters were selected from [0:0.05:0.5,10:10:100]. For the t-SVD-MS and ETLMSC algorithms, their hyperparameters were selected from [0.1:0.1:2] and [10⁻⁴:10⁻⁴: 10⁻³: 10⁻³:10⁻³: 10⁻², . . . , 10¹: 10¹: 10²], respectively. For the CGLMVC algorithm provided in the embodiment, the nearest neighbor parameter is set to 15. λ and C were selected using a grid search strategy from the [1,5,10,50,100,500,1000,5000]. To ensure a fair comparison, each experiment is repeated 20 times, and the average results were given. In addition, seven indexes including accuracy (ACC), normalized mutual information (NMI), adjusted Rand index (ARI), F-score, Precision, Recall, and Purity were used to evaluate the clustering performance according to the embodiment. Higher values of these seven indexes indicate better surface clustering performance.

### Analysis of Results

Table 1 shows the seven clustering index results for different methods on the six databases. The following conclusions can be drawn from the embodiment.

(1) The CGLMVC algorithm significantly outperforms the other comparative algorithms. Taking the MSRCV1 dataset as an example, the CGLMVC algorithm outperforms the second-best SM2SC algorithm by 5.24, 10.66, and 5.24 percentage points in terms of ACC, NMI, and Purity indexes, respectively. This validates the advantages and effectiveness of the method provided in the embodiment. The CGLMVC algorithm can achieve a better clustering effect for two main reasons. Firstly, the CGLMVC algorithm learns the similarity graph from the spectral embedding matrix instead of the original features. Secondly, simultaneous spectral embedding and low-rank tensor learning enables the obtaining of high-quality spectral embedding features.

(2) The CGLMVC algorithm outperforms the MCGC, MLAN, GMC, and ETLMSC algorithms, which are graph-based multi-view clustering algorithms. MLAN, GMC, and ETLMSC algorithms learn the similarity graph from the original features for clustering. However, the presence of noise and redundant information in the original features limits the ability of the learned similarity graph to reveal the intrinsic structure of the data, thereby restricting their clustering effect. MCGC algorithm mines the pairwise correlations between multiple views and learns a consistent similarity graph from spectral embeddings for clustering. Therefore, its clustering performance is also limited.

(3) The CGLMVC algorithm outperforms the LT-MSC, t-SVD-MS, and ETLMSC, three tensor-based multi-view clustering algorithms, on most datasets. This indicates that learning similarity graphs for clustering in the spectral embedding feature space yields better results compared to the original feature space.

(4) Compared to the LT-MSC, t-SVD-MS, and SM2SC, three subspace-based multi-view clustering algorithms, the CGLMVC algorithm achieves the best results on most datasets. The reason for the relatively good performance of LT-MSC and t-SVD-MS algorithms on the 20newsgroups dataset may be that the removal of outliers by norm l_{2,1} enables the subspace segmentation to effectively mine the cluster structure of the data.

(5) SC and LRR are two effective single-view clustering algorithms. Compared to other comparative methods, they often achieve feasible or even better clustering effects. However, the CGLMVC algorithm can achieve a better clustering effect on all datasets. This indicates the superiority of the CGLMVC algorithm.

TABLE 1

| Datasets | Method | F-score | Precision | Recall | NMI | AR | ACC | Purity |
|---|---|---|---|---|---|---|---|---|
| MSRCV1 | SC-SB | 0.6684 | 0.6354 | 0.7051 | 0.7109 | 0.6118 | 0.7548 | 0.7810 |
| | LRR-SB | 0.5434 | 0.5354 | 0.8914 | 0.5561 | 0.4686 | 0.6793 | 0.6810 |
| | MLAN | 0.6858 | 0.6111 | 0.7813 | 0.7629 | 0.6278 | 0.7238 | 0.7905 |
| | MCGC | 0.6857 | 0.6602 | 0.7468 | 0.7375 | 0.6328 | 0.7571 | 0.8048 |
| | GMC | 0.7997 | 0.7856 | 0.8144 | 0.8200 | 0.7668 | 0.8952 | 0.8952 |
| | SM2SC | 0.8027 | 0.7994 | 0.8060 | 0.8001 | 0.7708 | 0.8952 | 0.8952 |
| | LT-MSC | 0.7376 | 0.7270 | 0.7484 | 0.7560 | 0.6946 | 0.8429 | 0.8429 |
| | t-SVD-MS | 0.7076 | 0.6843 | 0.7366 | 0.7347 | 0.6584 | 0.8095 | 0.8095 |
| | ETLMSC | 0.6152 | 0.5969 | 0.6347 | 0.6257 | 0.5510 | 0.7376 | 0.7567 |
| | CGLMVC | 0.8945 | 0.8914 | 0.8975 | 0.8883 | 0.8774 | 0.9476 | 0.9476 |
| ORL | SC-SB | 0.7446 | 0.6998 | 0.7960 | 0.9141 | 0.7383 | 0.7950 | 0.8339 |
| | LRR-SB | 0.7657 | 0.7169 | 0.8220 | 0.9255 | 0.7599 | 0.8151 | 0.8476 |
| | MLAN | 0.3544 | 0.2347 | 0.7233 | 0.8312 | 0.3316 | 0.6850 | 0.7350 |
| | MCGC | 0.5644 | 0.4780 | 0.7606 | 0.8656 | 0.5525 | 0.7200 | 0.7800 |
| | GMC | 0.3599 | 0.2321 | 0.8011 | 0.8571 | 0.3367 | 0.6325 | 0.7150 |
| | SM2SC | 0.6419 | 0.6091 | 0.7168 | 0.8539 | 0.6332 | 0.7624 | 0.7813 |
| | LT-MSC | 0.7663 | 0.7203 | 0.8188 | 0.9207 | 0.7605 | 0.8163 | 0.8481 |
| | t-SVD-MS | 0.7679 | 0.7303 | 0.8216 | 0.9221 | 0.7623 | 0.8209 | 0.8460 |
| | ETLMSC | 0.7024 | 0.6639 | 0.7459 | 0.8903 | 0.6951 | 0.7734 | 0.8021 |
| | CGLMVC | 0.8584 | 0.8446 | 0.8727 | 0.9454 | 0.8551 | 0.8996 | 0.9074 |
| 20newsgroups | SC-SB | 0.6078 | 0.5276 | 0.7167 | 0.5643 | 0.4915 | 0.6600 | 0.7040 |
| | LRR-SB | 0.6295 | 0.6163 | 0.9840 | 0.5464 | 0.5353 | 0.7840 | 0.7840 |
| | MLAN | 0.5237 | 0.4222 | 0.6895 | 0.5248 | 0.3682 | 0.5900 | 0.6500 |
| | MCGC | 0.6170 | 0.5079 | 0.7859 | 0.6495 | 0.4954 | 0.6620 | 0.7060 |
| | GMC | 0.9643 | 0.9642 | 0.9643 | 0.9392 | 0.9554 | 0.9820 | 0.9820 |
| | SM2SC | 0.9683 | 0.9680 | 0.9685 | 0.9511 | 0.9604 | 0.9840 | 0.9840 |
| | LT-MSC | 0.9799 | 0.9798 | 0.9801 | 0.9652 | 0.9750 | 0.9900 | 0.9900 |
| | t-SVD-MS | 0.9799 | 0.9798 | 0.9801 | 0.9652 | 0.9750 | 0.9900 | 0.9900 |
| | ETLMSC | 0.3699 | 0.3315 | 0.9730 | 0.2523 | 0.1881 | 0.4189 | 0.4525 |
| | CGLMVC | 0.9721 | 0.9721 | 0.9722 | 0.9513 | 0.9652 | 0.9860 | 0.9860 |
| 100leaves | SC-SB | 0.5494 | 0.5222 | 0.5797 | 0.8283 | 0.5449 | 0.6651 | 0.6871 |
| | LRR-SB | 0.3572 | 0.3406 | 0.3755 | 0.7285 | 0.3508 | 0.4979 | 0.5294 |
| | MLAN | 0.3626 | 0.2533 | 0.6378 | 0.8285 | 0.3539 | 0.6388 | 0.6694 |
| | MCGC | 0.5637 | 0.5150 | 0.6787 | 0.8382 | 0.5592 | 0.7025 | 0.7263 |
| | GMC | 0.5042 | 0.3521 | 0.8874 | 0.9292 | 0.4974 | 0.8238 | 0.8506 |
| | SM2SC | 0.6461 | 0.5848 | 0.7330 | 0.8871 | 0.6423 | 0.7809 | 0.8057 |
| | LT-MSC | 0.6433 | 0.6129 | 0.6773 | 0.8699 | 0.6397 | 0.7339 | 0.7595 |
| | t-SVD-MS | 0.6707 | 0.6388 | 0.7059 | 0.8829 | 0.6674 | 0.7542 | 0.7788 |
| | ETLMSC | 0.7164 | 0.6742 | 0.7670 | 0.9065 | 0.7135 | 0.7756 | 0.8001 |
| | CGLMVC | 0.9431 | 0.9276 | 0.9590 | 0.9818 | 0.9425 | 0.9625 | 0.9646 |
| COIL20 | SC-SB | 0.8016 | 0.7711 | 0.8437 | 0.9106 | 0.7909 | 0.8389 | 0.8597 |
| | LRR-SB | 0.7684 | 0.7394 | 0.8000 | 0.8688 | 0.7558 | 0.8010 | 0.8224 |
| | MLAN | 0.8110 | 0.7213 | 0.9261 | 0.9405 | 0.7999 | 0.8424 | 0.8736 |
| | MCGC | 0.7282 | 0.6808 | 1.0000 | 0.8867 | 0.7130 | 0.7764 | 0.8139 |
| | GMC | 0.7997 | 0.6952 | 0.9411 | 0.9415 | 0.7876 | 0.8035 | 0.8465 |
| | SM2SC | 0.7637 | 0.7028 | 0.8804 | 0.9077 | 0.7497 | 0.7684 | 0.8155 |
| | LT-MSC | 0.7183 | 0.6881 | 0.7528 | 0.8423 | 0.7030 | 0.7710 | 0.7840 |
| | t-SVD-MS | 0.7273 | 0.7010 | 0.7559 | 0.8428 | 0.7126 | 0.7727 | 0.7882 |
| | ETLMSC | 0.7410 | 0.7311 | 0.7512 | 0.8422 | 0.7274 | 0.7788 | 0.7911 |
| | CGLMVC | 0.8440 | 0.8238 | 0.8653 | 0.9193 | 0.8357 | 0.8596 | 0.8832 |
| handwritten | SC-SB | 0.9225 | 0.9221 | 0.9229 | 0.9163 | 0.9139 | 0.9600 | 0.9600 |
| | LRR-SB | 0.7290 | 0.7018 | 0.7585 | 0.7679 | 0.6978 | 0.7795 | 0.8105 |
| | MLAN | 0.9475 | 0.9468 | 0.9482 | 0.9400 | 0.9417 | 0.9735 | 0.9735 |
| | MCGC | 0.8970 | 0.8948 | 0.8991 | 0.8926 | 0.8856 | 0.9465 | 0.9465 |
| | GMC | 0.8661 | 0.8268 | 0.9093 | 0.9057 | 0.8505 | 0.8820 | 0.8820 |
| | SM2SC | 0.9252 | 0.9244 | 0.9259 | 0.9163 | 0.9169 | 0.9615 | 0.9615 |
| | LT-MSC | 0.8195 | 0.8167 | 0.8223 | 0.8346 | 0.7995 | 0.8982 | 0.8982 |
| | t-SVD-MS | 0.8608 | 0.8577 | 0.8640 | 0.8653 | 0.8454 | 0.9255 | 0.9255 |
| | ETLMSC | 0.7629 | 0.7604 | 0.7654 | 0.7835 | 0.7366 | 0.8635 | 0.8635 |
| | CGLMVC | 0.9554 | 0.9549 | 0.9559 | 0.9491 | 0.9505 | 0.9775 | 0.9775 |

To verify that the learned embedding features by the CGLMVC algorithm are more conducive than the original features to constructing intrinsic similarity graphs for clustering tasks, this embodiment obtains view-specific similarity graphs and average similarity graphs from both the original features and the learned embedding features, respectively. Then, spectral clustering is performed on these similarity graphs, and the clustering accuracy (ACC) index is recorded according to the embodiment. As shown in Table 2, with an increasing number of iterations, the learned embedding features by the CGLMVC algorithm of the embodiment can construct better similarity graphs, providing an improved clustering effect. This effectively validates the superiority of the CGLMVC algorithm.

TABLE 2

| | | | Original | Spectral embedding features | | | | | |
|---|---|---|---|---|---|---|---|---|---|
| Datasets | Views | | features | t = 1 | t = 20 | t = 40 | t = 60 | t = 80 | t = 100 |
| MSRCV1 | View specific | 1 | 0.7548 | 0.7524 | 0.8667 | 0.8667 | 0.8714 | 0.8667 | 0.8667 |
| | | 2 | 0.2852 | 0.2762 | 0.2714 | 0.2714 | 0.2714 | 0.2714 | 0.2667 |
| | | 3 | 0.7143 | 0.7095 | 0.7381 | 0.7333 | 0.7333 | 0.7381 | 0.7381 |
| | | 4 | 0.6374 | 0.6236 | 0.8429 | 0.8762 | 0.8762 | 0.8714 | 0.8667 |
| | | 5 | 0.6183 | 0.6048 | 0.7095 | 0.8000 | 0.7952 | 0.8000 | 0.8000 |
| | | 6 | 0.4205 | 0.4286 | 0.4374 | 0.4652 | 0.4588 | 0.4583 | 0.4583 |
| | View averaging | | 0.8143 | 0.8952 | 0.9286 | 0.9381 | 0.9381 | 0.9429 | 0.9476 |
| ORL | View specific | 1 | 0.6465 | 0.6485 | 0.8764 | 0.8864 | 0.8981 | 0.8985 | 0.8986 |
| | | 2 | 0.7950 | 0.7949 | 0.8773 | 0.8845 | 0.8965 | 0.9006 | 0.9004 |
| | | 3 | 0.6943 | 0.6988 | 0.8796 | 0.8811 | 0.8859 | 0.8885 | 0.8870 |
| | View averaging | | 0.7598 | 0.8251 | 0.8771 | 0.8821 | 0.8943 | 0.8991 | 0.8996 |
| 20NGs | View specific | 1 | 0.6320 | 0.6300 | 0.9720 | 0.9660 | 0.9660 | 0.9700 | 0.9640 |
| | | 2 | 0.6600 | 0.6520 | 0.9780 | 0.9760 | 0.9740 | 0.9640 | 0.9480 |
| | | 3 | 0.3259 | 0.3620 | 0.9480 | 0.9200 | 0.9280 | 0.9560 | 0.9580 |
| | View averaging | | 0.9640 | 0.6300 | 0.9840 | 0.9860 | 0.9880 | 0.9860 | 0.9720 |
| COIL20 | View specific | 1 | 0.7903 | 0.4433 | 0.5083 | 0.6589 | 0.6864 | 0.8542 | 0.8507 |
| | | 2 | 0.7842 | 0.6131 | 0.5694 | 0.5435 | 0.6981 | 0.8368 | 0.8340 |
| | | 3 | 0.7506 | 0.5896 | 0.5294 | 0.4879 | 0.5528 | 0.8667 | 0.8625 |
| | View averaging | | 0.8389 | 0.5057 | 0.4932 | 0.5009 | 0.6263 | 0.8438 | 0.8590 |
| 100leaves | View specific | 1 | 0.6651 | 0.6730 | 0.7074 | 0.7188 | 0.7213 | 0.7252 | 0.7283 |
| | | 2 | 0.3694 | 0.3798 | 0.3972 | 0.3966 | 0.4040 | 0.4037 | 0.4008 |
| | | 3 | 0.5384 | 0.5529 | 0.5845 | 0.5912 | 0.5958 | 0.5998 | 0.6067 |
| | View averaging | | 0.8797 | 0.9503 | 0.9632 | 0.9654 | 0.9644 | 0.9681 | 0.9658 |
| handwritten | View specific | 1 | 0.9600 | 0.9570 | 0.9680 | 0.9730 | 0.9781 | 0.9785 | 0.9775 |
| | | 2 | 0.7185 | 0.7160 | 0.8140 | 0.8860 | 0.8830 | 0.8845 | 0.8835 |
| | | 3 | 0.7506 | 0.7485 | 0.9680 | 0.9745 | 0.9735 | 0.9775 | 0.9775 |
| | | 4 | 0.6638 | 0.6145 | 0.8405 | 0.8810 | 0.8350 | 0.8795 | 0.8865 |
| | | 5 | 0.9480 | 0.9555 | 0.9695 | 0.9735 | 0.9715 | 0.9765 | 0.9775 |
| | | 6 | 0.4432 | 0.4756 | 0.4730 | 0.5450 | 0.5590 | 0.5625 | 0.5715 |
| | View averaging | | 0.9715 | 0.9760 | 0.9750 | 0.9750 | 0.9775 | 0.9785 | 0.9780 |

### Parameter Sensitivity

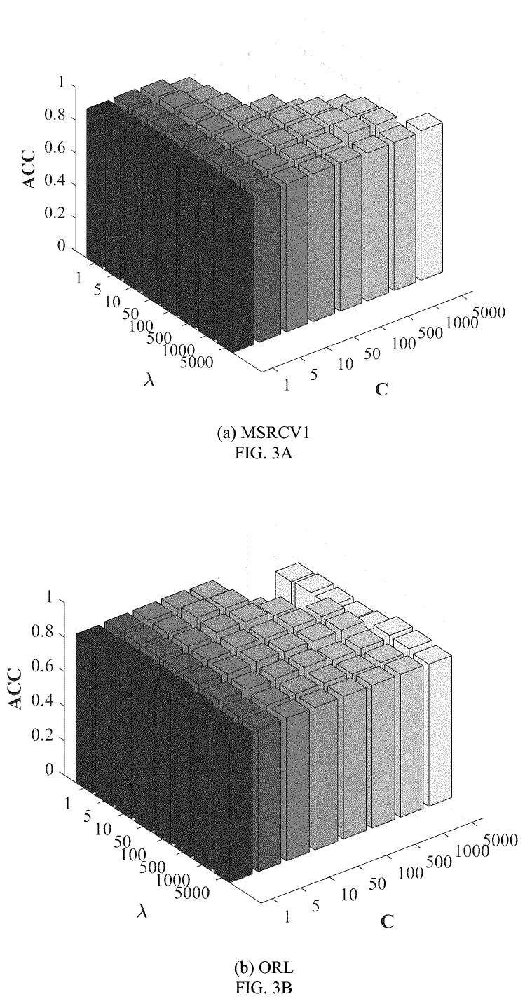

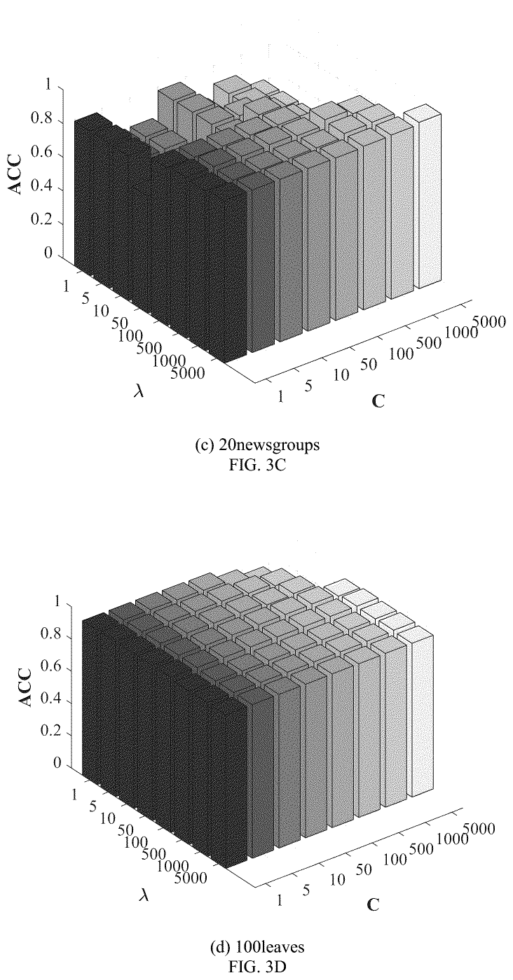

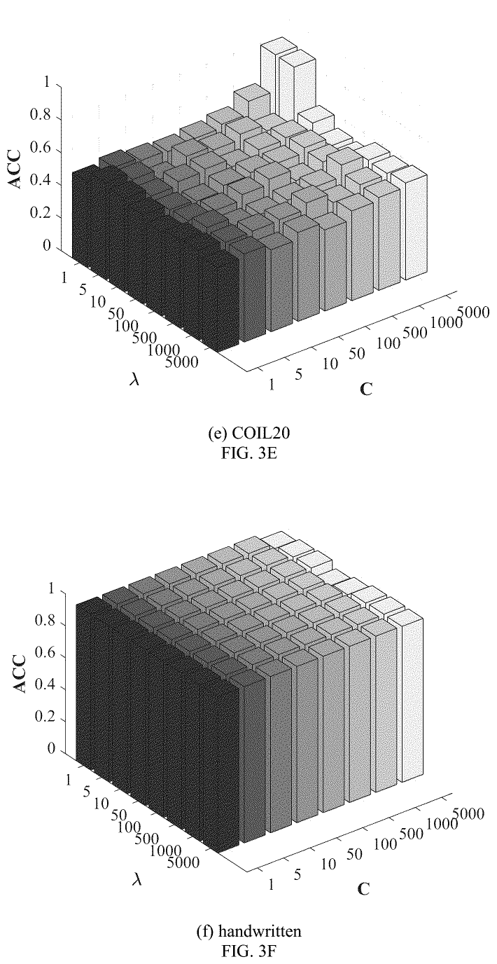

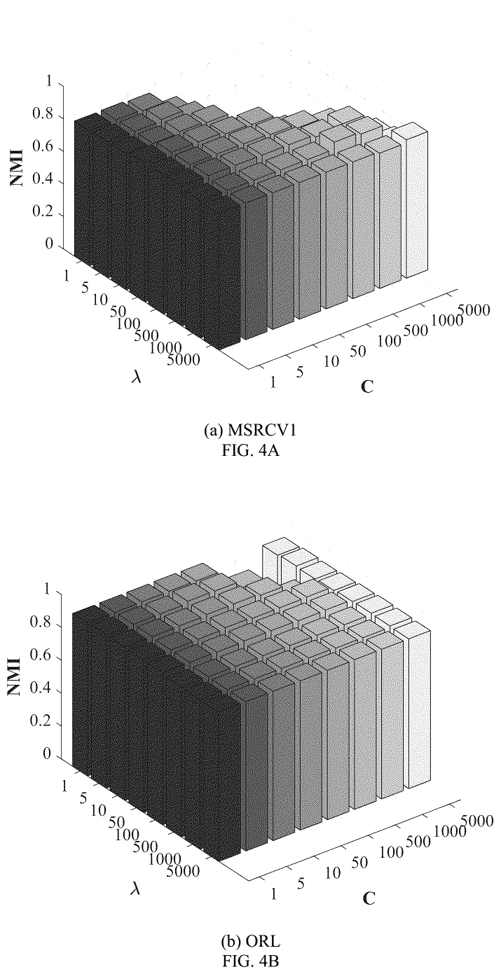

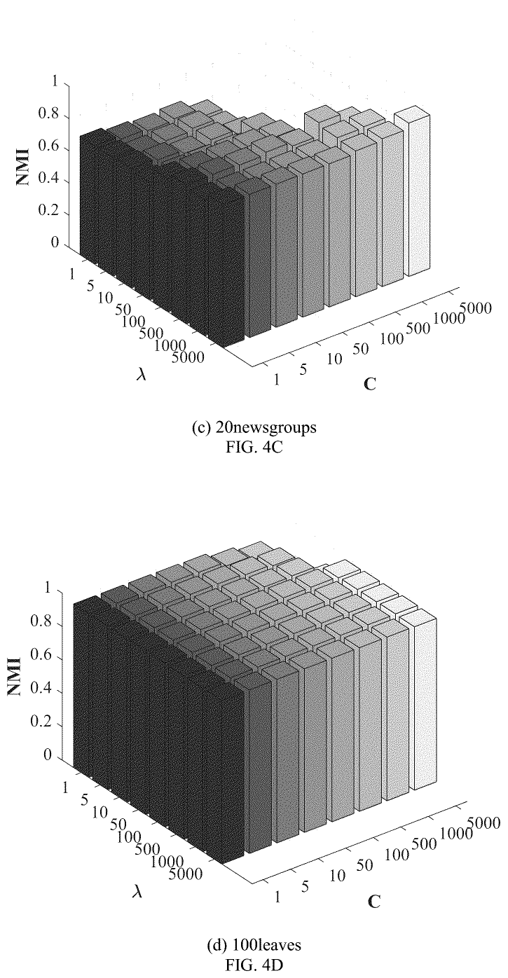

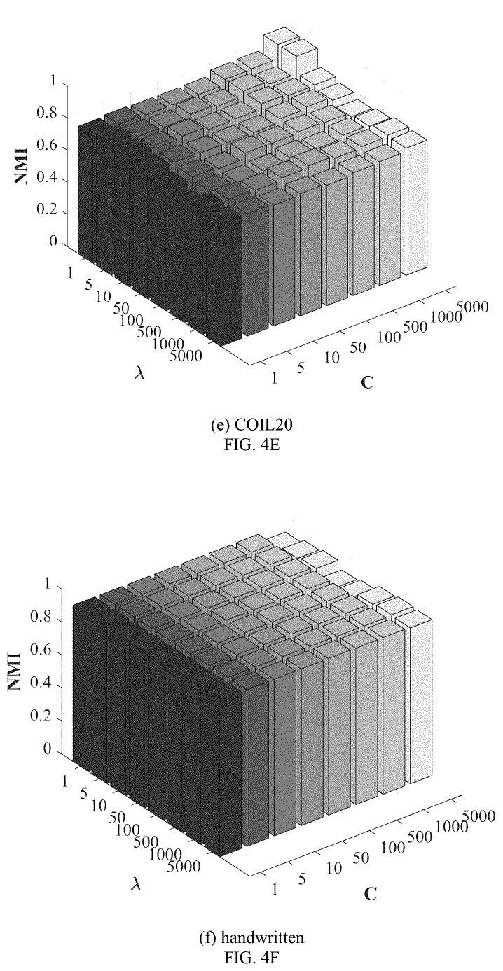

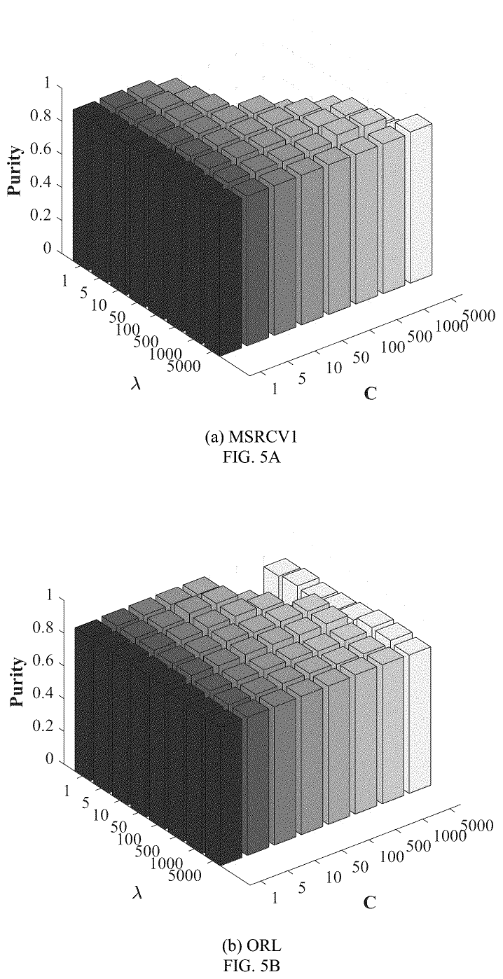

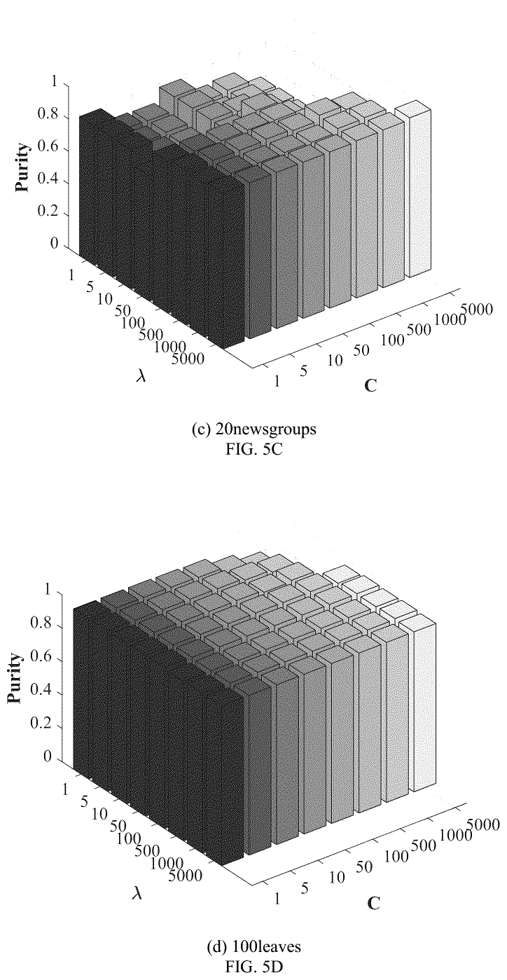

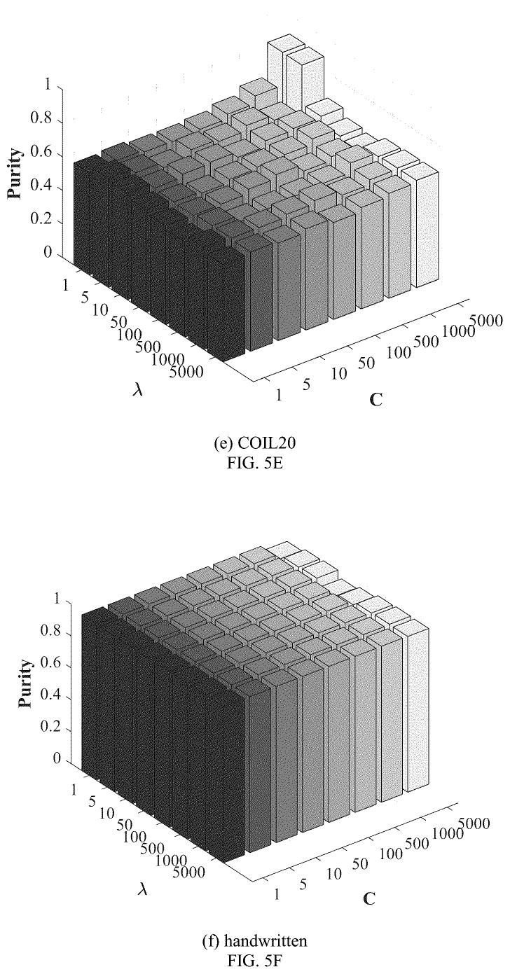

The present application contains two parameters λ and C . In the experiments of the embodiment, the parameters λ and C were selected from the range [1, 5,10,50,100,500,1000,5000] using grid search. FIGS. 3A-3F, FIGS. 4A-4F, and FIGS. 5A-5F show the ACC, NMI, and Purity results of the CGLMVC algorithm respectively on the six datasets under different parameter combinations. For the MSRCV1, ORL, 100leaves, and handwritten datasets, the CGLMVC algorithm is not sensitive to parameter perturbations and achieves satisfactory results across a wide range of parameter combinations. However, for the COIL20 dataset, the performance of the CGLMVC algorithm is highly dependent on the selection of parameters.

### Computational Complexity Analysis of the CGLMVC Algorithm

In the optimization process of solving the objective function, the computational complexity mainly lies in updating variables {H^{(v)}}ᵥ₌₁^{V} and [symbol] . For updating variable {H^{(v)}}ᵥ₌₁^{V} , it requires the complexity of [symbol] (n²c) to compute, in each iteration, the eigenvectors corresponding to the c largest eigenvalues in a n×n matrix. For updating variable [symbol] , it requires the complexity of [symbol] (n²Vlog(n)) and [symbol] (n²V²) to perform fast Fourier transform, inverse fast Fourier transform, and singular value decomposition on a nxV matrix, respectively. For computing the similarity graph and spectral clustering, it requires the computational complexity of [symbol] (nlog((n)) and [symbol] (n²c) , respectively. Therefore, the overall computational complexity of the CGLMVC algorithm is [symbol] (tVn²c+tn²Vlog(n)+tn²V²+nlog(n)+n²c), wherein t represents the number of iterations.

### Empirical Convergence of the CGLMVC Algorithm:

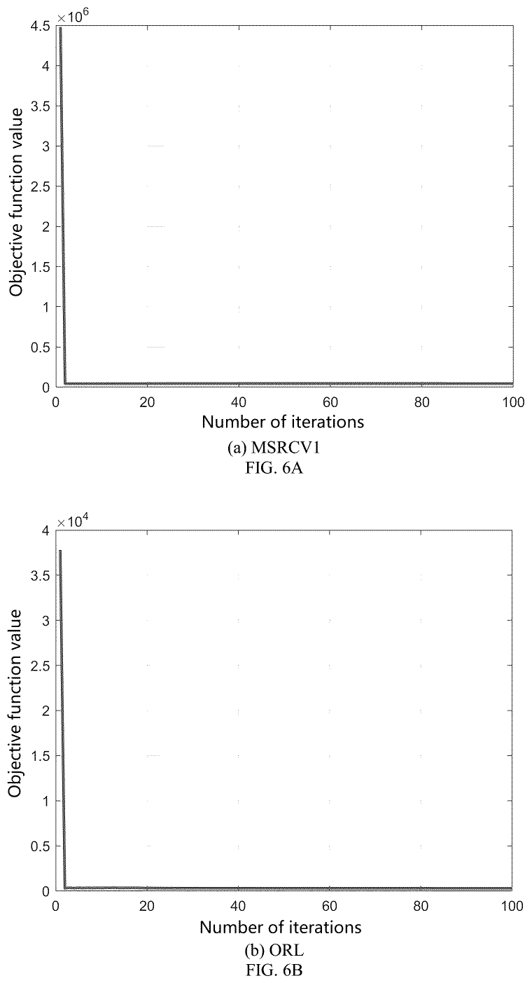

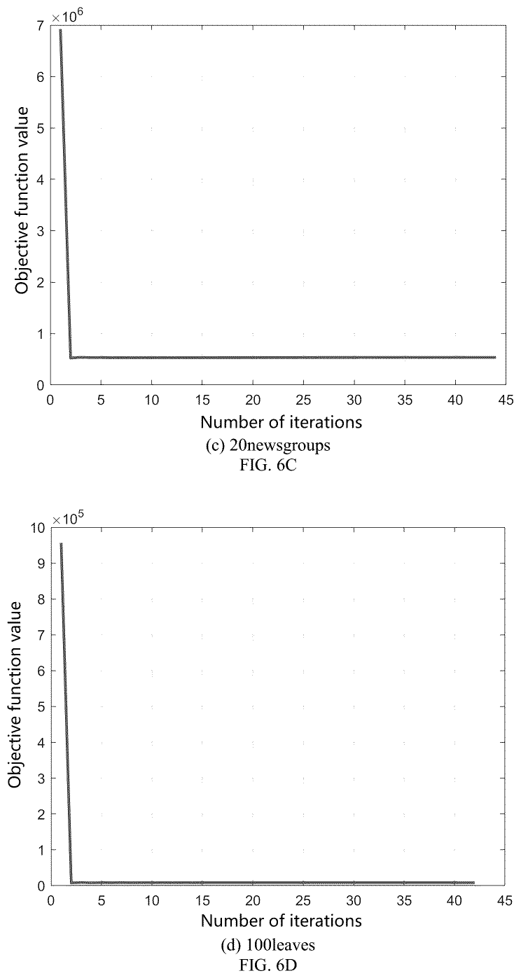

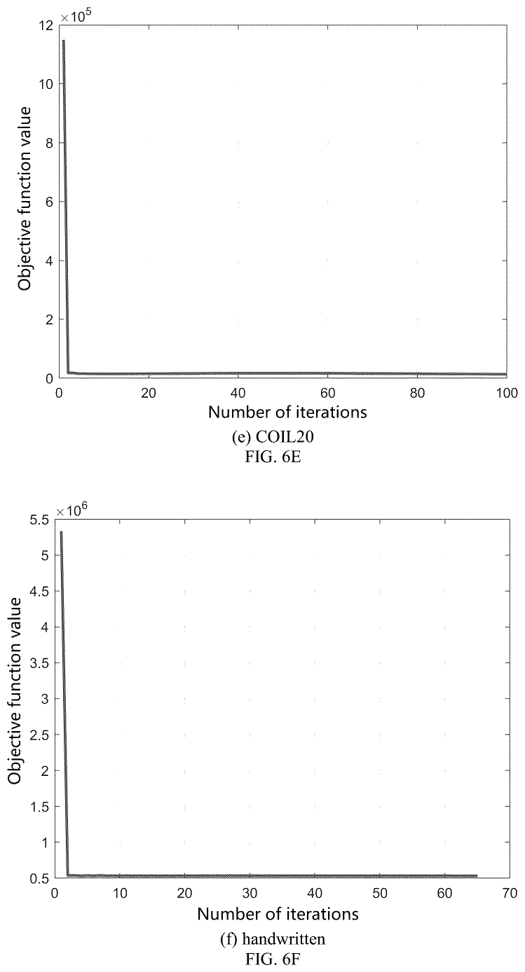

To verify the convergence of the CGLMVC algorithm, this embodiment recorded the convergence curves of the objective function of the algorithm on six datasets. As shown in FIGS. 6A-6F, the objective function value of the algorithm gradually decreases with the number of iterations and converges to a stable value within 100 iterations. Therefore, the CGLMVC algorithm exhibits good convergence.

It should be noted that the above is only the preferred embodiments of the present application and the principles of the employed technologies. It should be understood by those skilled in the art that the present application is not limited to the particular embodiments described herein, and those skilled in the art can make various obvious changes, rearrangements, and substitutions without departing from the protection scope of the present application. Therefore, although the above embodiments have provided a detailed description of the present application, the application is not limited to the above embodiments, and may further include other equivalent embodiments without departing from the spirit of the present application, and the scope of the present application is determined by the scope of the appended claims.

What is claimed is:

1. A consensus graph learning-based multi-view clustering method, comprising:
S1, inputting an original data matrix to obtain a spectral embedding matrix;
S2, calculating a similarity graph matrix and a Laplacian matrix based on the spectral embedding matrix;
S3, applying spectral clustering to the similarity graph matrix to obtain spectral embedding representations;
S4, stacking inner products of normalized spectral embedding representations into a third-order tensor and using low-rank tensor representation learning to obtain a consistent distance matrix;
S5, integrating spectral embedding representation learning and low-rank tensor representation learning into a unified learning framework to obtain a objective function;
S6, solving the objective function through an alternative iterative optimization strategy to obtain a solved result;
S7, constructing a consistent similarity graph based on the solved result; and
S8, applying spectral clustering to the consistent similarity graph to obtain a clustering result.

2. The consensus graph learning-based multi-view clustering method according to claim 1, wherein obtaining the spectral embedding representations in step S3 is expressed as:
max_{H}^{(v)}Tr(H^{(v)T}A^{(v)}H^{(v)}) s t. H^{(v)}H^{(v)T}=I_{c},
wherein H^{(v)} ∈ [symbol] ^{n×c} represents a spectral embedding matrix of a v-th view; A^{(v)} represents a Laplacian matrix of the v-th view; n represents a number of data samples; c represents a number of clusters; Tr( )represents a trace of a matrix; H^{(v)T} represents transpose of H^{(v)}; and I_{c} represents a c×c identity matrix.

3. The consensus graph learning-based multi-view clustering method according to claim 2, wherein using the low-rank tensor representation learning to obtain the consistent distance matrix in step S4 is expressed as:
$${min}_{τ} \frac{1}{2} {‖ ℬ - 𝒯 ‖}_{F}^{2} + {‖ 𝒯 ‖}_{w ,} * s . t . ℬ = Φ {( {\overline{H}}^{( 1 )} {\overline{H}}^{( 1 ) ⊤} , … , - {\overline{H}}^{( V )} {\overline{H}}^{( V ) ⊤} )}_{,}$$
wherein [symbol] ∈ [symbol] ^{n×V×n} represents a third-order tensor; [symbol] ∈ [symbol] ^{n×V×n} represents a third-order tensor; V represents a number of views; ∥∥_{F} represents a norm of a tensor; ∥∥_{w,*} represents a weighted tensor nuclear norm; Φ( ) represents a stacking of matrices into a tensor; H̅⁽¹⁾ and H̅^{(v)} represent normalized spectral embedding representations of first and V -th views, respectively, and H̅^{(1)T} H and H̅^{(V)T} represent transposes of H̅⁽¹⁾ and H̅^{(V)}, respectively.

4. The consensus graph learning-based multi-view clustering method according to claim 3, wherein obtaining the objective function in step S5 is expressed as:
$${min}_{{H}^{( v )} , 𝒯} - λ {\sum }_{v = 1}^{V} Tr ( {H}^{( v ) ⊤} {A}^{( v )} {H}^{( v )} ) + \frac{1}{2} {‖ ℬ - 𝒯 ‖}_{F}^{2} + {‖ 𝒯 ‖}_{w ,} * s . t . {H}^{( v ) ⊤} {H}^{( v )} = {I}_{c} ,$$
wherein λ represents a penalty parameter.

5. The consensus graph learning-based multi-view clustering method according to claim 4, wherein step S6 comprises:
S61, fixing [symbol] and unfolding tensors [symbol] and [symbol] into matrix form by discarding irrelevant terms, then the objective function being expressed as:
$${min}_{{H}^{( v )}} - λ Tr ( {H}^{( v ) ⊤} {A}^{( v )} {H}^{( v )} ) + \frac{1}{2} {‖ {\overline{H}}^{( v )} {\overline{H}}^{( v ) ⊤} - {T}^{( v )} ‖}_{F}^{2} s . t . {H}^{( v ) ⊤} {H}^{( v )} = {I}_{c} ,$$
wherein T^{(v)} represents a ν-th lateral slice of [symbol] ;
S62, making P^{(v)}∈ [symbol] ^{n×n} represent a diagonal matrix, then diagonal elements being defined as:
$${P}_{ij}^{( v )} = \{ \begin{matrix}\frac{1}{\sqrt{{h}_{i}^{( v ) ⊤} {h}_{i}^{( v )}}} , & if i = j \\ 0 , & otherwise\end{matrix} ,$$
wherein hᵢ^{(v)} and hⱼ^{(v)} represent i-th and j-th rows of spectral embedding matrix H^{(v)}, respectively; hᵢ^{(v)T} represents a transpose of hⱼ^{(v)};
solving {H^{(v)}}ᵥ₌₁^{V};
S63, fixing {H^{(v)}}ᵥ₌₁^{V} and discarding other irrelevant terms, then the objective function being expressed as:
$${min}_{𝒯} \frac{1}{2} {‖ ℬ - 𝒯 ‖}_{F}^{2} + {‖ 𝒯 ‖}_{w} * ,$$
$${min}_{\overline{𝒯} ( : , : , j )} \frac{1}{n} {\sum }_{j = 1}^{n} ( \frac{1}{2} {‖ \overline{ℬ} ( : , : , j ) - \overline{𝒯} ( : , : , j ) ‖}_{F}^{2} + {‖ \overline{𝒯} ( : , : , i ) ‖}_{w} * ) ,$$
wherein [symbol] (:, :, j) and) [symbol] (:,:, j) represent a j-th slice of [symbol] and a j-th slice of [symbol] respectively; [symbol] and [symbol] represent results of fast Fourier transform along a third dimension for [symbol] and [symbol] respectively;
S64, solving [symbol] (:,:, j) to obtain a solution of the objective function.

6. The consensus graph learning-based multi-view clustering method according to claim 5, wherein constructing the consistent similarity graph in step S7 is expressed as:
$${min}_{S} {{\sum }_{v = 1}}^{V} {\sum }_{i = 1}^{n} {{\sum }_{j = 1}}^{n} {‖ {\overline{h}}_{i}^{( v )} - {\overline{h}}_{j}^{( v )} ‖}_{2}^{2} {S}_{ij} + γ {‖ S ‖}_{F}^{2} s . t . {s}_{ij} \geq 0 , {s}_{i} {1}_{n} = 1 ,$$
wherein h̅ᵢ^{(v)} and h̅ⱼ^{(v)} represent i -th and j -th rows of H̅^{(v)}, respectively; S represents a consistent similarity graph; γ represents a penalty parameter.

7. The consensus graph learning-based multi-view clustering method according to claim 6, wherein in the tensor low-rank representation learning, solving the weighted nuclear norm is expressed as:
$${min}_{𝒯} \frac{1}{2} {‖ ℬ - 𝒯 ‖}_{F}^{2} + {‖ 𝒯 ‖}_{w} * ,$$
wherein for tensor χ∈Rⁿ^{₁}^{×n}^{₂}^{×n}^{₃}, there is
$${‖ 𝒳 ‖}_{F} = \frac{1}{\sqrt{{n}_{3}}} {‖ \overline{𝒳} ‖}_{F} ;$$
thus the following equivalent formulation holds:
$${min}_{{\overline{𝒯}}_{( : , : , j )}} \frac{1}{n} {\sum }_{j = 1}^{n} ( \frac{1}{2} {‖ \overline{ℬ} ( : , : , j ) - \overline{𝒯} ( : , : , j ) ‖}_{F}^{2} {‖ \overline{𝒯} ( : , : , i ) ‖}_{w ,} * ) ,$$
wherein [symbol] (:,:, j) and [symbol] (:,:, j) represent the j-th slice of [symbol] and the j-th slice of [symbol] , respectively; [symbol] and [symbol] represent the results of fast Fourier transform along the third dimension for [symbol] and [symbol] , respectively; [symbol] =fft( [symbol] =fft( [symbol] , []3) , [symbol] =fft( [symbol] , [], 3); [symbol]
(:, :, j) has the following approximate solution: [symbol]
(:, :, j)= [symbol] (:, :, j)* [symbol] (:, :,)* [symbol] (:,:, j)*,
wherein [symbol] (:, :,)= [symbol] (:,:, j)* [symbol] (:,:,j)* [symbol] (:,:, j)* represents a singular value decomposition of [symbol] (:,:, j); [symbol] (:, :, j) is defined as:
$$\tilde{\overline{𝒮}} ( i , i , j ) = \{ \begin{matrix}0 , & if {c}_{2} < 0 \\ \frac{{c}_{1} + \sqrt{{c}_{2}}}{2} , & if {c}_{2} \geq 0\end{matrix} ,$$
wherein c₁= [symbol] (i, i, j)−ϵ, c₂=( [symbol] (i, i, j)+ϵ)²−4C; ϵ is a positive value small enough that inequality
$$ϵ < min ( \sqrt{C} , \frac{C}{\overline{S} ( i , i , j )} )$$
holds; C is a constraint parameter for setting weight
$${w}_{i}^{( j )} , {w}_{i}^{( j )} = \frac{C}{\overline{𝒮} ( i , i , j ) + ϵ} .$$
